(19) United States
(12) Patent Application Publication
(10) Pub. No.: US 2016/0061440 A1
(43) Pub. Date: Mar. 3, 2016

(54) APPARATUS FOR PULSATION-FREE AND OSCILLATION-FREE TOTAL EVAPORATION OF MEDIA; HAND-HELD DEVICE FOR EVAPORATION OF SURFACES

(71) Applicant: Universitaet Stuttgart, Stuttgart (DE)

(72) Inventor: Holger ASCHENBRENNER, Stuttgart (DE)

(73) Assignee: UNIVERSITAET STUTTGART, Stuttgart (DE)

(21) Appl. No.: 14/840,950

(22) Filed: Aug. 31, 2015

(30) Foreign Application Priority Data
Sep. 2, 2014 (DE) 10 2014 013 019.3

(51) Int. Cl. F22B 1/28; H05B 3/14

(52) U.S. Cl. CPC F22B 1/282; H05B 3/141

(57) ABSTRACT

An apparatus for pulsation-free and oscillation-free total evaporation of media has an evaporation pipe having at least one inlet and at least one outlet for the media to be evaporated, and a displacement body is disposed coaxially, at least in a part of the evaporation pipe, wherein the displacement body lies against an inner wall of the evaporation pipe, at least over a part of its longitudinal expanse, so that at least one evaporation channel is formed, and the evaporation pipe can be temperature-regulated by a heating device, and the displacement body has an at least triangular cross-section, has a greater length expanse than width expanse, and is twisted about its longitudinal axis.

### CROSS REFERENCE TO RELATED APPLICATIONS

Applicant claims priority under 35 U.S.C. §119 of German Application No. 10 2014 013 019.3 filed Sep. 2, 2014, the disclosure of which is incorporated by reference.

### BACKGROUND OF THE INVENTION

1. Field of the Invention

The invention relates to an apparatus for pulsation-free and oscillation-free total evaporation of media, as well as a hand-held device for evaporation of surfaces.

2. Description of the Related Art

The production of pulsation-free streams of vapor for the most varied application sectors, for example in laboratory and experiment technology, is a highly demanding task, because in this connection, continuous and complete evaporation of the media to be evaporated is required. Evaporation is supposed to make do without an addition of carrier gases, to function in robust and reliable manner, i.e. to proceed independent of disruptions, for the most part. A prerequisite for this feature is a phase transition of the medium to be evaporated, particularly of a liquid, into the vapor phase (evaporation), without disruptive side effects, such as, for example, uncontrolled bubble formation. Pulsations, variations and/or pressure surges occur because of these side effects, which are typical for boiling processes and are the rule.

Apparatuses for pulsation-free and oscillation-free evaporation of small volume streams (throughputs) and their production methods have been state of the art for a long time. For example, there are the most varied applications in all technical application sectors, with the most varied liquids, wherein the evaporation must always function precisely under conditions from vacuum to excess pressure (at this time approximately up to 60 bar), from room temperature to high temperature. For this purpose, evaporation apparatuses, particularly falling film evaporators and microchannel evaporators are used. It has been shown that these evaporation apparatuses still have optimization potential, both with regard to pulsation-free and oscillation-free evaporation and with regard to contamination and clogging of the evaporation apparatus due to deposits in the evaporation channels. Furthermore, their production methods are often complicated and/or production is very cost-intensive.

Thus, evaporators for small throughputs in the range of 0.01-1 g/h are known. Throughputs >0.01 g/h (approximately 5 μl/min) are therefore state of the art and can be implemented with corresponding technical knowledge. Lower throughputs, in the lower μl range or even the nl range, however, have set new standards with a volume stream that is up to 1000 times smaller.

The Offenlegungsschrift DE 199 63 594 A1 shows an apparatus using microstructure technology, for passing media through, which apparatus is particularly suitable for evaporation of liquid media. The apparatus has a layer-type structure, having at least a first layer that has a number of microchannels and through which a heat carrier medium flows. It is a disadvantage of this technical solution that the apparatus cannot guarantee pulsation-free and oscillation-free evaporation of volume streams on the order of microliters (μl) or nanoliters (nl).

The patent DE 101 32 370 B4 protects an apparatus and a method for evaporation of liquid media. The apparatus uses at least one first heater part for heating and at least partial evaporation of a liquid medium, with at least one channel for passing the medium through and at least one first heating device, at least one second heater part for further heating the heated medium, with at least one channel for passing the medium through and at least one second heating apparatus, and at least one interstice between a first heater part and a second heater part and/or between two first heater parts and/or between two second heater parts for homogenization and/or eddying and/or evaporation as well as passing on of the heated medium from the exit of at least one channel of a first heater part to the entry of at least one channel of a subsequent heater part. It is a disadvantage of this technical solution that the apparatus cannot guarantee pulsation-free and oscillation-free evaporation of volume streams on the order of microliters (μl) or nanoliters (nl).

The patent DE 40 29 260 C1 shows an evaporator, wherein the total evaporation in this regard takes place as falling film evaporation in the ring gap between concentric heated pipes. It is a disadvantage of the technical solution shown in the aforementioned patent that adjustment of a uniform falling film is problematical for small throughputs of liquid, and these ring gap evaporators, like all total evaporators, furthermore also tend toward greatly pulsating vapor production, wherein larger regions of liquid overheat and then evaporate suddenly. Beyond these drawbacks, the production of such an evaporator is cost-intensive. Furthermore, evaporation of volume streams on the order of microliters or nanoliters cannot be implemented by means of the aforementioned technical solution.

In the Offenlegungsschrift DE 197 23 680 A1, a total evaporator for small flows of liquid is described, in which the liquid to be evaporated is passed first through a cold space, which is temperature-regulated in such a manner that pre-evaporation of liquid is prevented, and subsequently through a hot space, in at least one small pipe or at least one bore, wherein the total evaporation takes place in the at least one narrow small pipe or in the at least one bore, respectively, in order to prevent surge-like, non-uniform evaporation, to a great extent.

In addition, non-evaporated droplets of liquid are prevented from being ejected, by means of installations such as coils or wire spirals, for example, in the at least one small evaporator pipe. The at least one small pipe or the at least one bore opens into a vapor space that minimizes possible variations in vapor production, as a pulsation damper, so that controlled, low-pulsation total evaporation can be ensured over a wide throughput range with an apparatus disclosed in the Offenlegungsschrift.

Disadvantages of this arrangement are the complex structure and the complicated production, with multiple narrow and long bores or small pipes, and the aforementioned installations that must be installed for every bore or small pipe. In this technical solution, as well, evaporation of volume streams on the order of microliters (μl) or nanoliters (nl) cannot be implemented.

The Offenlegungsschrift DE 10 2005 023 956 A1 shows a total evaporator for liquids, consisting of a cold space for preventing pre-evaporation, an evaporation region that follows it, having a narrow flow cross-section for rapid evaporation of the liquid, and a subsequent vapor space for pulsation damping and for controlled overheating of the vapor. The evaporation region is formed by the gap between cylindrical or conical pipe pieces that lie concentrically in one another, and the heat required for evaporation or overheating is introduced either by means of electrical heating, by means of a hot fluid, or by means of catalytic or homogeneous combustion, by way of the wall of the concentric pipes.

It is disadvantageous, in this regard, that only a slight surface area is made available for evaporation by means of the evaporation channels, and that the evaporation channels can very quickly become clogged by deposits. Furthermore, the production of the evaporation channels requires great technical and time-intensive effort, and the production tools are subject to great wear.

Furthermore, the evaporation zone extends to cover only a small region, therefore it is not possible to use the heating cartridge optimally or it can be used only by way of a solid construction of the evaporator, which brings with it increased material expenditure and production effort.

Furthermore, the at least one evaporation channel tends to become clogged quickly and completely, thereby making disassembly difficult due to caking of the material, in the case of great contamination and a long-term period of use, because of the design (fit), and in the past, this tendency has led to destruction in the case of improper handling, or made repair by the manufacturer necessary. An additional disadvantage of the technical solution is that evaporation of volume streams on the order of microliters or nanoliters cannot be implemented with it.

### SUMMARY OF THE INVENTION

The invention is therefore based on the task of developing an apparatus for pulsation-free and oscillation-free total evaporation of media, which requires lower production-technology expenditure, while guaranteeing that the evaporation quality is kept at least the same, and, connected with these features, also requires lower production costs, and, for another thing, the ability to implement evaporation of volume streams on the order of microliters or nanoliters.

The task of the development of an apparatus for pulsation-free and oscillation-free total evaporation of media, particularly of liquids, wherein the apparatus has an evaporation pipe having at least one inlet and at least one outlet for the media to be evaporated, and a displacement body is disposed coaxially, at least in a part of the evaporation pipe, wherein the displacement body lies, at least over a part of its longitudinal expanse, against an inner wall of the evaporation pipe, so that at least one evaporation channel is formed, and the evaporation pipe can be temperature-regulated by means of a heating device, is accomplished, according to the apparatus according to the invention, in that the displacement body has a greater length expanse than width expanse, and an at least triangular cross-section, wherein the displacement body is twisted about its longitudinal axis.

### The Invention and Its Advantages

The apparatus according to one aspect of the invention, for pulsation-free and oscillation-free total evaporation of media, has the advantage that the feed of media by way of the inlet, the heating system, and the outlet are designed to be dimensioned for microscale construction spaces (microliter to nanoliter range). Furthermore, the apparatus according to the invention can be produced without great production effort and therefore very cost-advantageously. The apparatus according to the invention has the further advantage that it allows complete and surge-free evaporation of the metered medium, particularly of a liquid such as water. Because of small cross-sectional surface areas, high flow speeds occur in the vapor phase, which produce a vapor jet at the outlet from the evaporation pipe. It is furthermore advantageous that the apparatus according to the invention makes a technology available for controlled and defined microfilm formation (by means of condensation) on surfaces, without these surfaces being contaminated. The evaporator principle that has been developed can furthermore be used for numerous liquid media, for the formation of defined condensation surface areas. A further advantage of the solution according to the invention is that in this way, very small, compact evaporators can be built, which are very efficient, with maximally great performance capacity. Beyond these advantages, the apparatus is very well suited for and can be used for applications under stationary conditions as well as applications under highly dynamic conditions. In addition, step-free design of the apparatus is possible, so that the apparatus can be used from the microscale range (nanoliters) all the way to the macroscale range (milliliters). A further advantage is that functionality of the apparatus can be guaranteed independent of its position.

According to an advantageous embodiment of the apparatus according to the invention, the displacement body has a microstructured surface. The microstructured surface has a greater evaporation surface, therefore making it possible for the entering medium to be evaporated more quickly.

According to an additional advantageous embodiment of the apparatus according to the invention, the inner wall of the evaporation pipe has a microstructured surface. The microstructured surface of the inner wall of the evaporation pipe has a greater evaporation surface, thereby making it possible for the entering medium to be evaporated more quickly, in more controlled and defined manner.

According to an additional advantageous embodiment of the apparatus according to the invention, the displacement body consists of a porous material. What is advantageous about this feature is that in this way, the surface that stands available for evaporation of the medium is increased by a multiple and therefore the evaporation can take place even more efficiently.

According to an additional advantageous embodiment of the apparatus according to the invention, the evaporation pipe is temperature-regulated by a heating device, by means of heat radiation. What is advantageous about energy introduction by means of heat radiation directly onto the evaporation zone is that the heat is transported indirectly, by way of heat conduction, in the evaporation pipe, mainly in the direction of the outlet of the evaporation pipe, thereby making it possible to produce and regulate correspondingly low, adapted heat outputs. As a result, the inlet region of the evaporation pipe also remains cooler, and this counteracts pre-evaporation of the entering medium.

According to an additional advantageous embodiment of the apparatus according to the invention, a nozzle is disposed at the outlet from the evaporation pipe. The use of a nozzle has the advantage that the formation of a targeted vapor jet is achieved by mixing with ambient air.

According to an advantageous embodiment of the apparatus according to the invention, in this regard, a targeted vapor jet is produced by means of a special nozzle. When impacting on a colder surface, a circular condensate surface area forms, as a function of the duration of the vapor application.

According to an additional advantageous embodiment of the apparatus according to the invention, a vapor jet that has been produced is drip-free and can be regulated in terms of temperature and/or flow rate. The advantage is that in this way, systematic application of a homogeneous condensate layer, which is required for uniform contrasting, to a region of a sample that is of interest, for example of a fingerprint, is made possible.

The apparatus according to another aspect of the invention, for pulsation-free and oscillation-free total evaporation of media, has a displacement body with a greater length expanse them width expanse and an at least triangular cross-section. The displacement body is twisted about its longitudinal axis, and a woven fabric material that increases the surface area is disposed between the evaporation pipe and the displacement body. The apparatus has the advantage that the feed of media by way of the inlet, the heating system, and the outlet are designed to be dimensioned for microscale construction spaces (microliter to nanoliter range).

Furthermore, the apparatus according to the invention can be produced without great production effort and therefore very cost-advantageously. The apparatus according to the invention has the further advantage that it allows complete and surge-free evaporation of the metered medium, particularly of a liquid such as water.

An additional advantage consists in that a greater surface is produced by means of the woven fabric material, thereby making it possible to bring about the phase transition of the medium to be evaporated, particularly of water or the like, in even easier and more controlled manner, and that a defined separation surface is formed in the two-phase region, between liquid in the inlet and gaseous vapor at the outlet, which furthermore also contributes to a further volume reduction.

It is furthermore advantageous that the apparatus according to the invention makes a technology available for controlled and defined microfilm formation (by means of condensation) on surfaces, without these surfaces being contaminated. The evaporator principle that has been developed can furthermore be used for numerous liquid media, for the formation of defined condensation surface areas.

According, to an advantageous embodiment of the apparatus according to the invention, the woven fabric material is preferably an expanded metal, a woven fabric, a hybrid woven fabric, a plastic woven fabric, a textile woven fabric, a porous material, a porous pipe, a knitted woven fabric, a woven woven fabric, a material having a roughened surface, a coated material, a net (mesh), a metal mesh, a chain-like woven fabric, a material having a capillary structure, a material having a sintered structure, a metal imprint, a laser-sintered woven fabric or the like.

According to an additional advantageous embodiment of the apparatus according to the invention, the displacement body has a microstructured surface. The microstructured surface has a greater evaporation surface, thereby making it possible for the entering medium to be evaporated more quickly.

According to an additional advantageous embodiment of the apparatus according to the invention, the inner wall of the evaporation pipe has a microstructured surface. The microstructured surface of the inner wall of the evaporation pipe has a greater evaporation surface, thereby making it possible for the entering medium to be evaporated more quickly, in more controlled and defined manner.

According to an additional advantageous embodiment of the apparatus according to the invention, the displacement body consists of a porous material. What is advantageous about this feature is that in this way, the surface that stands available for evaporation of the medium is increased by a multiple and therefore the evaporation can take place even more efficiently.

According to an additional advantageous embodiment of the apparatus according to the invention, a nozzle is disposed at the outlet from the evaporation pipe. What is advantageous about the use of a nozzle is that the formation of a targeted vapor jet is achieved by means of mixing with ambient air.

The hand-held device according to a further aspect of the invention, for the evaporation of surfaces, particularly for making fingerprints or the like visible in destruction-free manner, has disposed therein an apparatus for pulsation-free and oscillation-free total evaporation of media according to the invention. The hand-held device according to the invention advantageously makes available an evaporation system that reproducibly delivers the water vapor film in the required quality. Furthermore, the vapor amount of the hand-held device according to the invention can be regulated in terms of vapor temperature and/or mist density, and particularly does not have the very unpleasant property that droplets form in the vapor stream. The hand-held device furthermore permits systematic application of a homogeneous condensate layer which is required for uniform contrasting to the region of the sample that is of interest, and can furthermore be used universally.

Further advantages and advantageous embodiments of the invention can be derived from the following description, the claims, and the drawings.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a longitudinal section through a first exemplary embodiment of the apparatus according to the invention, for pulsation-free and oscillation-free total evaporation of media,

FIG. 2 shows a longitudinal section through a second exemplary embodiment of the apparatus according to the invention,

FIG. 3 shows a perspective representation of an exemplary embodiment of a twisted displacement body, and

FIGS. 4A and 4B show assembly instructions for assembly of the different components of a further exemplary embodiment of the apparatus according to the invention.

### DETAILED DESCRIPTION OF PREFERRED EMBODIMENTS

In FIG. 1, a longitudinal section through a first exemplary embodiment of the apparatus 1 according to the invention, for pulsation-free and oscillation-free total evaporation of media, is shown. The apparatus 1 according to the invention is dimensioned, in all of its components, for microscale construction spaces of the microliter (μl) or nanoliter (nl) range. The apparatus 1 has a housing 2, in which an evaporation pipe 3 is disposed. The evaporation pipe 3 does not have to have a circular cross-section, but rather can also have a polygonal cross-section or the like, for example. A displacement body 4 that is twisted about its longitudinal axis is introduced into the evaporation pipe 3, over its entire length, which body lies, at least over a part of its longitudinal expanse, against an inner wall 5 of the evaporation pipe 3.

Furthermore, the evaporation pipe 3 has an inlet 6 and an outlet 7 for the medium to be evaporated. The evaporation pipe 3 is temperature-regulated, particularly heated, by means of a heating device 8, so that medium fed in by way of the inlet 6, in the arrow direction 9, is evaporated in the evaporation pipe 3 and subsequently flows out into the surroundings by way of a nozzle 10 disposed at the outlet 7. In the present exemplary embodiment, a mantle heating system serves as a heating device 8.

The apparatus 1 according to the invention, in its arrangement, leads to complete, surge-free evaporation of the metered medium, particularly of water. Furthermore, the apparatus 1 according to the invention allows production of droplet-free vapor streams that can be regulated in terms of temperature and flow rate, which streams get into an open ambient system by way of the nozzle 10, particularly in directed manner.

Because of the small cross-sectional surface areas that occur between the evaporation pipe 3 and the displacement body 4, high flow speeds occur in the vapor phase, which speeds produce a vapor jet at the outlet 7. By means of the use of a special nozzle 10, which is suitable for mixing with ambient air, the formation of a targeted vapor jet is achieved. When this vapor jet impacts on a colder surface, a circular condensate surface forms, as a function of the period of vapor application. With the apparatus 1 according to the invention, a controlled condensate film can therefore be precisely applied to an exhibit or to a surface, in precise manner, and therefore serves as a technology for controlled microfilm formation (by means of condensation) on surfaces.

By the selective absorption of the condensate, for example water, in IR light (infrared light), microfilm formation can be utilized, in targeted manner, to increase contrast. In this way, it becomes possible, for example, to evaluate fingerprints on an absorbent substrate.

The basic idea in this regard has already been utilized for a long time by persons searching for traces; it is the old, tried and true “breathing on” a suspect region on a trace carrier, in order to make latent traces visible by means of contrast brought about by applying water vapor. Since DNA analyses have arisen for genetic identification of a perpetrator, however, this “breathing on” is no longer possible, because contamination of the traces by the DNA of the person searching for traces is unavoidable.

By means of the apparatus 1 according to the invention, water molecules can be applied to the suspect trace, for example the fingerprint, as components of a water vapor cloud, without contaminating it with regard to its DNA. In this way, local differences in the water molecule occupation density on the object being examined can already be made visible in daylight, because the water molecules concentrate between the lipid zones and the lipid zones cannot be wetted. The imaging contrast increases by several factors, up to powers of ten, by means of application of water to the trace. In addition to the water occupation in a controlled thickness, its uniformity in the surface area is important, above all, for the quality of the increase in contrast. The contrast reinforcement, for one thing, and high-resolution IR camera technology, on the other hand, allow detailed imaging of the trace in image qualities that are by no means inferior to conventional dactyloscopy. The apparatus 1 according to the invention is suitable for mobile applications, for example hand-held devices.

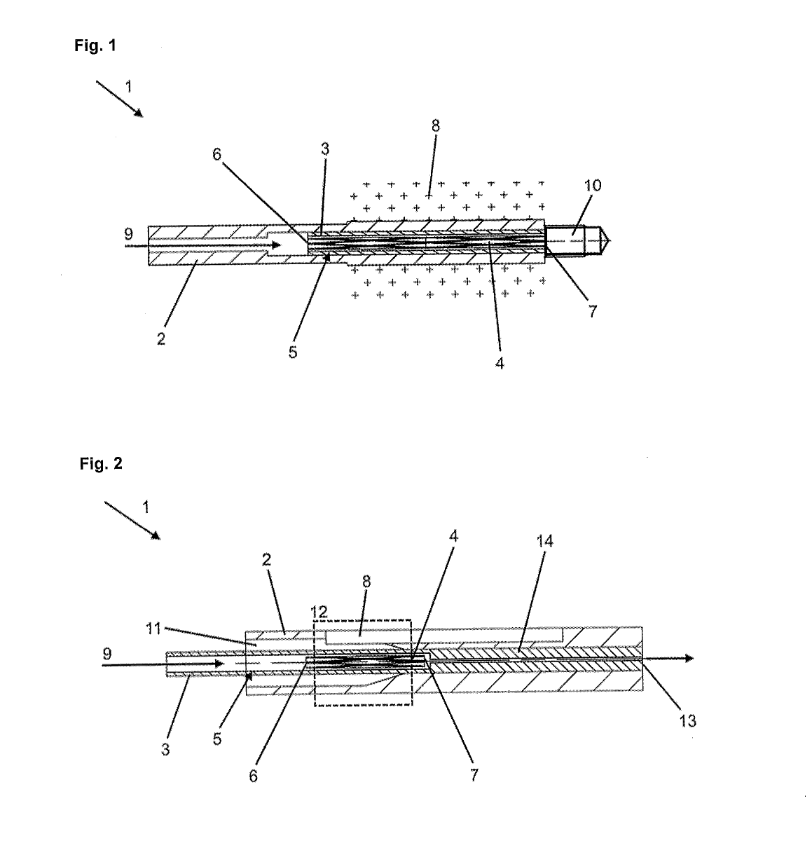

FIG. 2 shows a longitudinal section through a second exemplary embodiment of the apparatus 1 according to the invention. The apparatus 1 according to the invention is dimensioned, in all of its components, for microscale construction spaces of the microliter or nanoliter range. The apparatus 1 has a housing 2, in which an evaporation pipe 3 is disposed. Both in the case of the housing 2 and in the case of the evaporation pipe 3, the inside diameter is greater on the side of the inlet 6 of the medium to be evaporated than on the side of the outlet 7. A displacement body 4 that is twisted about its longitudinal axis is introduced into the evaporation pipe 3, over its entire length, which body lies, at least over a part of its longitudinal expanse, against an inner wall 5 of the evaporation pipe 3. The displacement body 4 is introduced into the evaporation pipe 3 until the inside diameter of the same narrows. The spiral-shaped geometry of the displacement body 4 disposed in the evaporation pipe 3 has the function, for one thing, of reducing the construction space to a minimum and avoiding direct gas ejection, by means of constant deflection of the vapor stream.

The medium to be evaporated flows, in the arrow direction 9, into the evaporation pipe 3, which is temperature-regulated, particularly heated, by means of a heating device 8. Because of the cavity 11, temperature-regulation of the evaporation pipe 3 takes place by means of heat radiation in the region of the evaporation pipe 3, and, indirectly, by way of heat conduction by way of the evaporation pipe 3, but only in the direction of the outlet 7. In this way, correspondingly low, adapted heat outputs can be produced and regulated.

Energy introduction by means of heat radiation results in gentle introduction of heat, without overheating, into the two-phase region of the evaporation zone 12, with a sufficiently low output, so that continuous evaporation can be produced by a continuous heat stream, and the liquid phase is transferred to the gaseous phase without disruptions. The inlet region remains cooler, as a result, and this coolness additionally prevents pre-evaporation of the entering medium. Ceramic micro heating elements with a platinum wire serve as a heating device 8, for example; these elements can be operated and regulated using low voltage.

Furthermore, because of the installation situation and the length of the rod-shaped heating devices 8, which can be disposed in the housing in the circumference direction, for example, the region of the outlet 7, 13 and of the transition region 14 of the evaporation pipe 3 disposed between the two outlets 7 and 13 can be sufficiently heated as well, in order to prevent condensation after the evaporation process. In this way, it is ensured that a medium fed in by way of the inlet 6, in the arrow direction 9, is evaporated in the evaporation pipe 3 and is subsequently passed from the outlet 7, through the transition region 14, to the outlet 13. A nozzle 10, not shown here, can be disposed at the outlet 13.

The vapor produced should not accumulate, as it does in a boiler, but rather should flow out directly into the adjacent surroundings. For this purpose, all the medium-conducting lines, particularly the evaporation pipe 3, must be restricted to a minimum of volume, i.e. these components are not allowed to have any dead volumes, or only minimally small dead volumes. Otherwise, continuous vapor production is not possible when metering the medium to be evaporated.

Furthermore, heating of the apparatus 1 is possible not only from the outside, as in the exemplary embodiments described in FIGS. 1 and 2, by means of a heating device 8, but also from the inside, for one thing, by means of a heating device 8, not shown, for example by means of heating from the interior of the displacement body 3, or, for another thing, also by means of heating from both sides, in other words a heating device 8, not shown, from the inside, and a heating device 8 on the outside. The heating device 8 of the apparatus 1 can preferably be structured as an electrical heating system, as heating by means of hot gases (waste air, waste gases), by means of other heat carriers such as water, oil or the like, by means of radiation, inductively or by means of self-regulating heating elements. Furthermore, integration into the most varied components is also possible, whereby the waste heat of the component can be used to heat the apparatus 1, for example. In this way, at least partial recovery of heat can take place.

The individual components of the two exemplary embodiments according to the invention shown in FIGS. 1 and 2 are preferably produced from aluminum, brass, silver, perfluoroalkoxy alkane (abbreviated PFA), polytetrafluoroethylene (abbreviated PTFE) or stainless steel. Furthermore, production of the individual components from plastic, metal, precious metal, non-ferrous metal or the like is possible, wherein the components can be designed for the vacuum sector, high-pressure sector and low-pressure sector.

The apparatus 1 can, as explained in FIGS. 1 and 2, be structured as an individual pipe. In addition, variants as cylindrically disposed multiple pipes, which are operated in parallel, or as a coaxial pipe arrangement (in shell shape), for example, of the apparatus 1 are conceivable and possible. In this way, the possibility exists of increasing the volume stream and thereby the throughput of evaporated media, in terms of amount, and of actually evaporating different media at the same time. Furthermore, location-independent positioning of the apparatus 1 is possible with guaranteed functionality of the apparatus 1.

If necessary, it is possible to cool the apparatus 1 according to the invention with air or with a vortex cooler, in order to prevent overheating or to keep media having a low boiling point cold in the feed line.

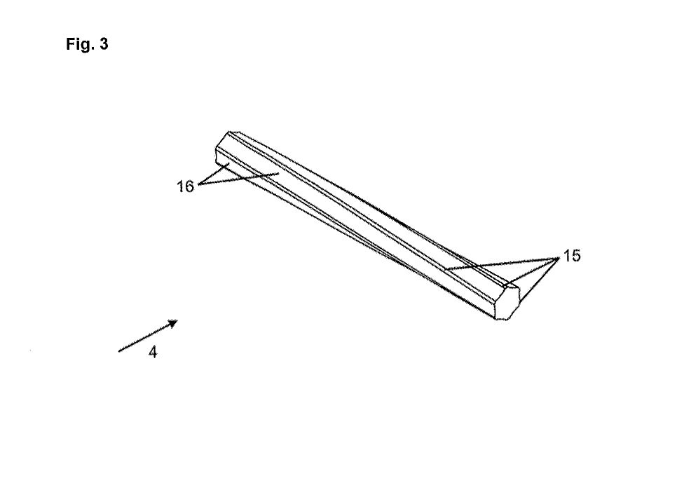

A perspective representation of an exemplary embodiment of the twisted displacement body 4 of the apparatus 1 according to the invention, for pulsation-free and oscillation-free total evaporation of media, is shown in FIG. 3. The displacement body 4 shown has a hexagonal cross-section and thereby has six edges 15 and six surfaces 16 in the circumference direction of its longitudinal expanse. The displacement body 4 can fundamentally have an n-gonal cross-section, wherein n corresponds to the number of corners, but must have at least a triangular cross-section. Furthermore, an evaporation channel according to the patent application DE 10 2014 009 785 can also be used as a displacement body 3. The displacement body 3 is preferably produced by means of twisting, opposite twisting (twisted first in one direction, then back in the opposite direction), twisting in sections (zigzag twisting of consecutive sections of the displacement body 3), meander-shaped twisting or the like, wherein the displacement body 3 has any desired angle of twist.

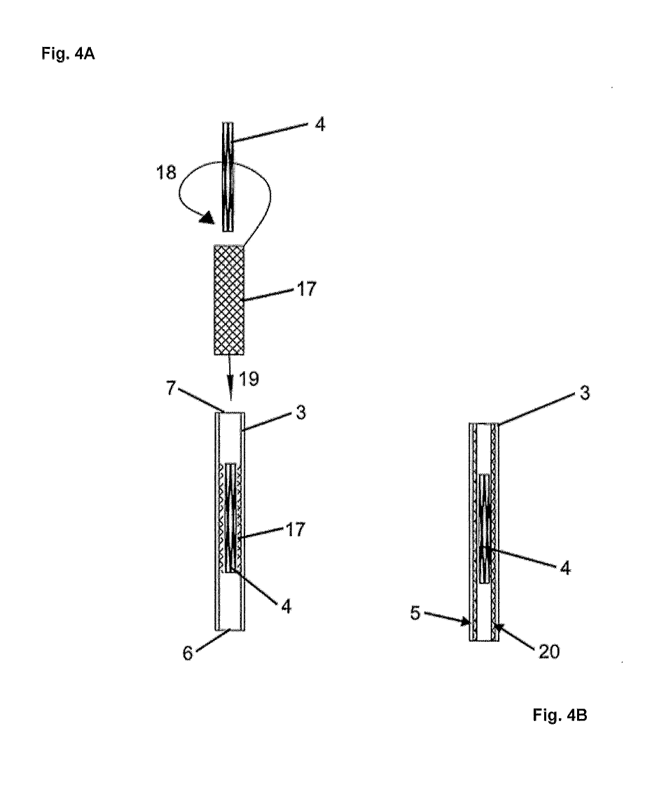

In FIG. 4A, assembly instructions for assembly of the individual components of a further exemplary embodiment of the apparatus 1 according to the invention is shown. In this regard, a woven fabric material 17 is wound around a displacement body 4 in the arrow direction 18. Subsequently, the displacement body 4, which has the woven fabric material 17 wound around it, is introduced into an evaporation pipe 3, in the arrow direction 19, in such a manner that it is disposed centered between an inlet 6 and an outlet 7. The woven fabric material 17 can have a surface that preferably is an expanded metal, a woven fabric, a hybrid woven fabric, a plastic woven fabric, a textile woven fabric, a porous material, a porous pipe, a knitted woven fabric, a woven woven fabric, a material having a roughened surface, a coated material, a net (mesh), a metal mesh, a chain-like woven fabric, a material having a capillary structure, a material having a sintered structure, a metal imprint, a laser-sintered woven fabric or the like.

FIG. 4B, in contrast, shows a displacement body 4 disposed centered in an evaporation pipe 3, wherein the inner wall 5 of the evaporation pipe 3 has a microstructured surface 20. In addition, it is possible that both the evaporation pipe 3 on its inner wall 5 and also the displacement body 4 have a structured surface 20, for example configured as porous surfaces, as grainy surfaces, as a sinter-type surface or as a combination thereof. For this purpose of increasing the surface, a wire woven fabric 17 introduced between evaporation pipe 3 and displacement body 4 can furthermore also be additionally disposed, as shown in FIG. 4A. Also, the entire displacement body 4 can consist of a porous material. In this way, a defined separation surface between liquid in the inlet 6 and gaseous vapor at the outlet 7 is formed in the two-phase region, which surface furthermore also contributes to a further reduction in size of the volume.

A design of the apparatus 1 is particularly undertaken by means of a combination of the different materials that can be used, or by means of a variation in geometry of the individual components of the apparatus 1, preferably by means of an adaptation of the surface characteristics or surface structure of the components used, of the displacement body 4 and of the evaporation pipe 3, here preferably of the length and/or of the diameter. Almost any desired design ability of the apparatus 1 results from the variability in material and/or number and/or size and/or structure. Therefore a step-free design of the apparatus is made possible, wherein volume streams in the microscale range (nanoliters) all the way to the macroscale range (milliliters) are possible.

All of the characteristics presented here can be essential to the invention both individually and in any desired combination with one another.

Although only at least two embodiments of the present invention have been shown and described, it is to be understood that many changes and modifications may be made thereunto without departing from the spirit and scope of the invention.

What is claimed is:

1. An apparatus for pulsation-free and oscillation-free total evaporation of media comprising:
(a) an evaporation pipe having an inner wall and at least one inlet and at least one outlet for the media to be evaporated;
(b) a displacement body disposed coaxially at least in a part of the evaporation pipe and having a longitudinal axis, a length expanse, and a width expanse less than the length expanse; and
(c) a heating device;
wherein the displacement body lies, at least over a part of the length expanse, against the inner wall so that at least one evaporation channel is formed;
wherein the evaporation pipe is temperature-regulatable by the heating device;
wherein the displacement body has an at least triangular cross-section; and
wherein the displacement body is twisted about the longitudinal axis.

2. The apparatus according to claim 1, wherein the displacement body has a microstructured surface.

3. The apparatus according to claim 1, wherein the inner wall of the evaporation pipe has a microstructured surface.

4. The apparatus according to claim 1, wherein the displacement body comprises a porous material.

5. The apparatus according to claim 1, wherein the healing device temperature-regulates the evaporation pipe by heat radiation.

6. The apparatus according to claim 1, further comprising a nozzle disposed at the at least one outlet.

7. The apparatus according to claim 6, wherein a targeted vapor jet is produced by the nozzle.

8. The apparatus according to claim 7, wherein the vapor jet that is produced is drip-free and is regulatable in terms of at least one of temperature and flow rate.

9. An apparatus for pulsation-free and oscillation-free total evaporation of media comprising:
(a) an evaporation pipe having at least one inlet and at least outlet for the media to be evaporated;
(b) a displacement body disposed coaxially at least in a part of the evaporation pipe and having a longitudinal axis, a length expanse, and a width expanse less than the length expanse;
(c) a heating device; and
(d) a woven fabric material disposed between the evaporation pipe and the displacement body and increasing surface area available for evaporation of the media;
wherein the evaporation pipe is temperature-regulatable by the heating device;
wherein the displacement body has an at least triangular cross-section; and
wherein the displacement body is twisted about the longitudinal axis.

10. The apparatus according to claim 9, wherein the woven fabric material is an expanded metal, a woven fabric, a hybrid woven fabric, a plastic woven fabric, a textile woven fabric, a porous material, a porous pipe, a knitted woven fabric, a woven woven fabric, a material having a roughened surface, a coated material, a net, a metal mesh, a chain-shaped woven fabric, a material having a capillary structure, a material having a sintered structure, a metal imprint, or a laser-sintered woven fabric.

11. The apparatus according to claim 9, wherein the displacement body has a microstructured surface.

12. The apparatus according to claim 9, wherein the evaporation pipe has an inner wall with a microstructured surface.

13. The apparatus according to claim 9, wherein the displacement body comprises a porous material.

14. The apparatus according to claim 9, further comprising a nozzle disposed at the at least one outlet.

15. A hand-held device for evaporation of a surface comprising:
(a) an interior; and
(b) an apparatus for pulsation-free and oscillation-free total evaporation of media disposed in the interior;
wherein the apparatus comprises:
an evaporation pipe having an inner wall and at least one inlet and at least one outlet for the media to be evaporated;
a displacement body disposed coaxially at least in a part of the evaporation pipe and having a longitudinal axis, a length expanse, and a width expanse less than the length expanse; and
a heating device
wherein the displacement body lies, at least over a part of the length expanse, against the inner wall so that at least one evaporation channel is formed;
wherein the evaporation pipe is temperature-regulatable by the heating device;
wherein the displacement body has an at least triangular cross-section; and
wherein the displacement body is twisted about the longitudinal axis.
